(19) United States
(12) Patent Application Publication
(10) Pub. No.: US 2019/0069678 A1
(43) Pub. Date: Mar. 7, 2019

(54) OVERTURN PREVENTING DEVICE

(71) Applicant: KYB CORPORATION, Minato-ku, Tokyo (JP)

(72) Inventors: Shinichi SEKINE, Minato-ku, Tokyo (JP); Akihisa OOTA, Minato-ku, Tokyo (JP)

(73) Assignee: KYB CORPORATION, Minato-ku, Tokyo (JP)

(21) Appl. No.: 16/086,484

(22) PCT Filed: Feb. 28, 2017
(86) PCT No.: PCT/JP2017/007683

§ 371 Date: Sep. 19, 2018

(30) Foreign Application Priority Data
Mar. 24, 2016 (JP) 2016-059644

(51) Int. Cl. A47B 97/00; F16B 1/00; F16F 9/06; F16F 7/00

(52) U.S. Cl. CPC A47B 97/00; F16B 1/0071; F16F 9/516; F16F 7/003; A47B 2097/008; F16F 9/061

(57) ABSTRACT

Providing an overturn preventing device which can inform in a case where a load applied to a base has changed. The overturn preventing device includes a damper to be mounted between a top surface of an article installed on an installation surface and a ceiling, and a pair of bases respectively coupled to both ends of the damper. One of the bases abuts against the top surface of the article and the other base abutting against the ceiling. The device further includes a shape-changeable part (an informing part) which informs in a case where the base has been subjected to a predetermined load.

### TECHNICAL FIELD

The present invention relates to an overturn preventing device.

### BACKGROUND ART

Patent Document 1 discloses a conventional overturn preventing device. This overturn preventing device includes a damper and a pair of bases. The damper is mounted between a top surface of a piece of furniture installed on a floor surface and a ceiling. The damper has two ends respectively supported by the paired bases to be rotatable about rotation axes. One of the bases abuts against the top surface of the furniture and the other base abuts against the ceiling. Accordingly, when the furniture is tilted by shaking of an earthquake or the like in a direction parallel to a rotation direction of the damper, the damper is rotated about the rotation axes relative to the bases with the result that the bases can be maintained in abutment against the top surface of the furniture and the ceiling respectively. Consequently, this overturn preventing device can apply a damping force of the damper to the furniture thereby to suppress the tilt of the furniture and prevent the furniture from overturn.

### PRIOR ART DOCUMENT

### Patent Documents

Patent Document 1: Japanese Patent Application Publication No. JP 2015-6330

### SUMMARY OF THE INVENTION

### Problem to be Overcome by the Invention

The overturn preventing device disclosed in Patent Document 1 can prevent an article from overturn by applying the damping force of the damper to the article even when an earthquake or the like shakes the article. However, when an excessively strong fluctuating load is applied to the base of the overturn preventing device due to an earthquake or the like or a fluctuating load is repeatedly applied to the base, there is a possibility of occurrence of deterioration or breakage in part of the base. If such deterioration or breakage is left unnoticed, there is a possibility that the overturn preventing device will be continued to be used in a state where the function to be exhibited cannot be fully exhibited.

The present invention was made in view of the above-described circumstances in the conventional art and has an object to provide an overturn preventing device which can inform when a load applied to the base has changed.

### Means for Overcoming the Problem

An overturn preventing device in accordance with the invention includes a damper to be mounted between a top surface of an article installed on an installation surface and a ceiling, and a pair of bases respectively coupled to both ends of the damper. One of the bases abuts against the top surface of the article and the other base abuts against the ceiling. The device further includes an informing part which informs in a case where either base has been subjected to a predetermined load.

Since the overturn preventing device in accordance with the invention includes the informing part which informs in a case where either base has been subjected to a predetermined load, it is possible to inform the user of the fact that the base has been subjected to the predetermined load after the overturn preventing device has been installed between the article and the ceiling. Consequently, the user can understand presence or absence of the predetermined load applied to the base, so that deterioration or damage caused by the load can be less likely to be left.

The informing part may have a shape-changeable part which changes a shape thereof when the base has been subjected to the predetermined load.

When the informing part is thus configured, the fact that the base has been subjected to the predetermined load can be informed to the user by the change in the shape of the shape-changeable part. In particular, it is possible to inform of the fact that the predetermined load has occurred by a simple configuration without complicated detection or control.

The predetermined load in the case where the shape-changeable part is provided means a load that changes the shape of the shape-changeable part.

The shape-changeable part may have a protrusion disposed on a peripheral edge of the base to extend outward.

When such a protrusion is provided on the peripheral edge of the base, deformation or breakage can be caused in the protrusion when the overturn preventing device is subjected to an intense fluctuating load in the occurrence of an earthquake or the like or when the overturn preventing device is repeatedly subjected to a fluctuating load. In particular, the protrusion can be selectively deformed or broken easily, while the function of the base is maintained. By such deformation or breakage of the protrusion, it is possible to inform that the load applied to the base has been changed.

A plurality of the protrusions may be provided on the peripheral edge of the base.

When a plurality of the protrusions is provided on the peripheral edge of the base, the protrusions tend to show changes according to the degree of the load applied to the base. For example, the number of the protrusions deformed or broken tends to be increased as the fluctuating load applied to the base becomes large. Furthermore, the number of the protrusions deformed or broken tends to be increased as the number of times of occurrence of the fluctuating load applied to the base is increased. In other words, it is possible to inform of a degree of deterioration or damage of the base by the number of the protrusions deformed or broken.

A plurality of types of the protrusions having different breaking strengths may be provided on the peripheral edge of the base.

In this configuration, the number of types of the protrusions deformed or broken is reduced as the degree (magnitude or number of times of occurrence) of the fluctuating load applied to the base is small, and the number of types of the protrusions deformed or broken is increased as the degree (magnitude or number of times of occurrence) of the fluctuating load applied to the base is large. As being thus configured, the protrusions tend to show a change in the positions or the number more accurately reflecting the degree of the fluctuating load received by the base. Therefore, it is possible to inform of the degree of deterioration of the base more accurately by the positions or the number of protrusions deformed or broken.

The protrusion may be independent of a body of the base. The body of the base may be provided with a mounting portion for mounting the protrusion.

When the protrusion and the base body are thus constructed, the protrusion can be attached to the base body at a desirable time. For example, the protrusion can be attached to the base after the base has been installed so as to abut against the ceiling or the article. Consequently, the protrusion is less likely to be erroneously damaged at the time of installation of the base, with the result that it is possible to inform of load change after installation of the overturn preventing device more accurately.

The body of the base and the protrusion may be bonded together by a bonding layer.

According to this configuration, even when a fluctuating load is applied to the base with the result that the protrusion is broken, the broken piece of the protrusion remains coupled to the body by the bonding layer. Therefore, while the breakage of the protrusion can inform of the occurrence of the load, the broken piece of the protrusion can be less likely to be scattered after breakage.

The informing part may have a display-changeable part which changes a display thereof when the base has been subjected to the predetermined load.

When the informing part is thus configured, it is possible to visually inform the user that the base has been subjected to the predetermined load by the change in the display of the display-changeable part.

The predetermined load in the case where the display-changeable part is provided means a load that changes the display of the display-changeable part.

The display-changeable part may have a pressure-sensitive sheet which changes a color thereof when the base has been subjected to the predetermined load.

According to this configuration, it is possible to inform that the base has been subjected to the predetermined load by the change in the color of the pressure-sensitive sheet. Moreover, since it is possible to inform by the sheet material, the informing part can be provided while suppressing the installation space.

The display-changeable part may have a detection part which detects pressure or strain caused in the base and a display part which displays a result of detection by the detection part.

According to this configuration, the state of pressure or strain caused in the base can be displayed by the display part. The user can easily take an appropriate measure against the overturn preventing device by visually recognizing the result of detection displayed on the display part.

The informing part may be provided at least on the ceiling-side base.

When the informing part is thus provided on the ceiling-side base, the informing part can be rendered more visible, so that the user can more easily understand the information contents.

Here, the article includes a piece of furniture, a bed having a plurality of beds connected to each other in the up-down direction, a large sized television, a refrigerator, a book shelf, a showcase, a server rack, and the like all of which have a possibility of being overturned by the shaking of an earthquake or the like.

### BRIEF DESCRIPTION OF THE DRAWINGS

FIG. 1 is a side view of the overturn preventing device of a first embodiment, mounted between the top surface of the furniture and the ceiling;

FIG. 2 is a front view of the overturn preventing device of the first embodiment, mounted between the top surface of the furniture and the ceiling;

FIG. 3 is a partially sectional view of a damper and a first base of the overturn preventing device of the first embodiment;

FIG. 4 is an exploded perspective view of the damper, the first base and a fall preventing part of the overturn preventing device of the first embodiment;

FIG. 5 is a partially sectional view of the damper, the first base and the fall preventing part of the first embodiment;

FIG. 6 is a partially sectional view of the damper, the first base and an angle regulator of the overturn preventing device of the first embodiment;

FIG. 7(A) is a partially sectional view partially and schematically showing a cross section of a part near a protrusion in the overturn preventing device of the first embodiment, and FIG. 7(B) is a partially sectional view of the part in a case where the protrusion has been broken at the position as illustrated in FIG. 7(A);

FIG. 8(A) is a partially sectional view partially and schematically showing a cross section of a part near the protrusion in the overturn preventing device of the second embodiment, and FIG. 8(B) is a partially sectional view of the part in a case where the protrusion has been broken at the position as illustrated in FIG. 8(A);

FIG. 9 is a perspective view schematically showing a part near the first base of the overturn preventing device of a third embodiment;

FIG. 10(A) is a partially sectional view partially and schematically showing a cross section of a part near the protrusion in the overturn preventing device of the third embodiment, and FIG. 10(B) is a partially sectional view of the part in a case where the protrusion has been broken at the position as illustrated in FIG. 10(A);

FIG. 11 is a perspective view schematically showing a part near the first base of the overturn preventing device of a fourth embodiment;

FIG. 12 is an exploded perspective view of the damper, the first base and the fall preventing part of the overturn preventing device of a fifth embodiment;

FIG. 13 is a perspective view showing a state where a display of a display-changeable has been changed in the first base of the overturn preventing device of the fifth embodiment;

FIG. 14 is an exploded perspective view of the damper, the first base and the fall preventing part of the overturn preventing device of a sixth embodiment; and

FIG. 15(A) is a block diagram schematically illustrating an electrical arrangement of the overturn preventing device of the sixth embodiment, and FIG. 15(B) is a block diagram illustrating another example differing from that of FIG. 15(A).

### BEST MODE FOR CARRYING OUT THE INVENTION

### First Embodiment

A first embodiment of the overturn preventing device in accordance with the present invention will be described with reference to the drawings.

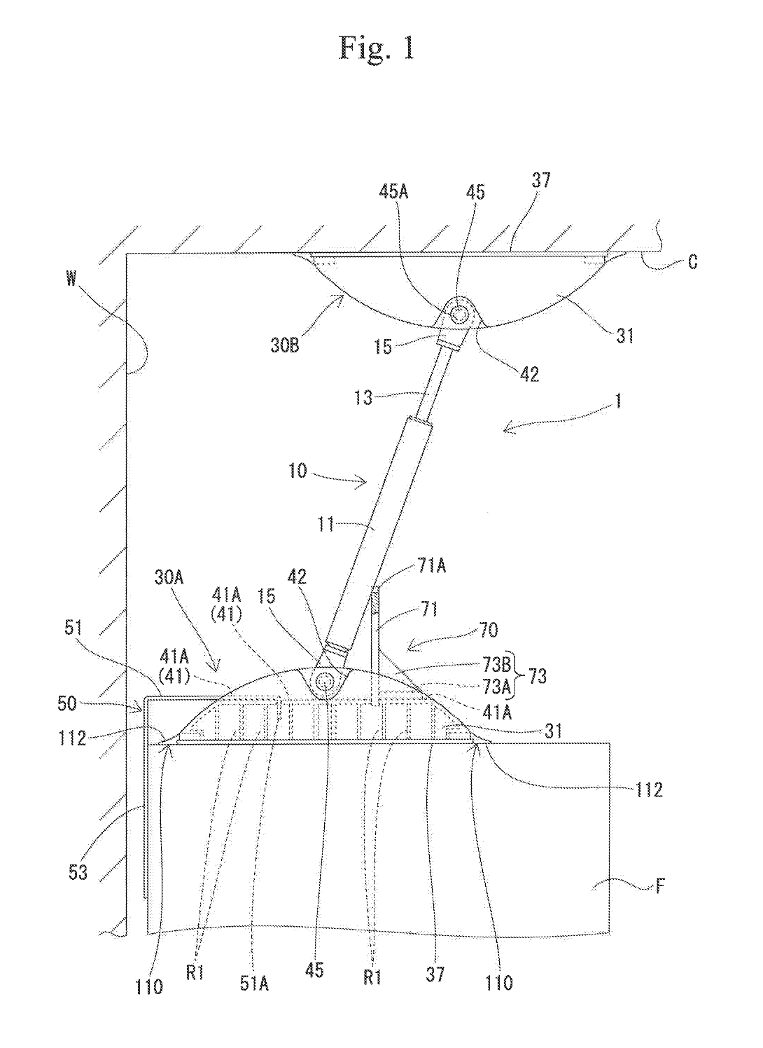

At least one overturn preventing device 1 of the first embodiment is mounted between a top surface of a piece of furniture F and a ceiling C, as illustrated in FIG. 1. The furniture F is installed on a floor surface (not illustrated) serving as an installation surface while a rear surface of the furniture F is opposed to a wall surface W extending in a vertical direction from the floor surface. The furniture F is formed into a rectangular parallelepiped shape, for example, and has a door, a drawer (neither illustrated) and the like in a front surface (a right side as viewed in FIG. 1), so that clothes, accessories and the like can be housed in the furniture F. The furniture F has a rectangle-shaped horizontal section long in a right-left direction (a depthwise direction in FIG. 1). When the overturn preventing device 1 as illustrated in FIG. 1 is not mounted on the furniture F, the furniture F would possibly be tilted frontward (rightward in FIG. 1) by shaking of an earthquake or the like thereby to be overturned.

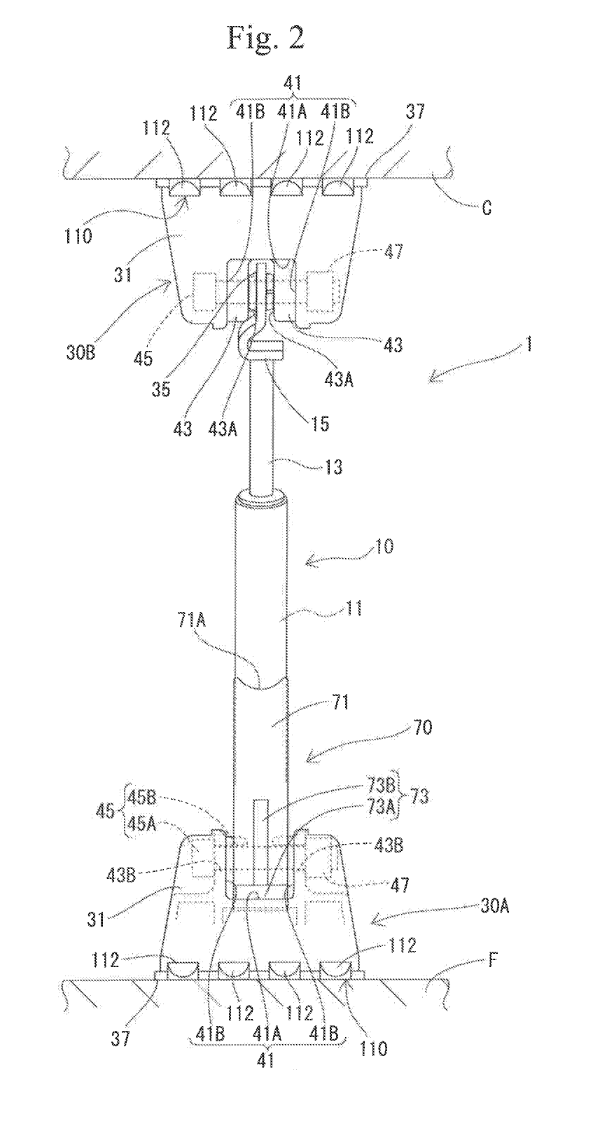

The overturn preventing device 1 includes a damper 10, a pair of bases 30A and 30B, a fall preventing part 50 and an angle regulator 70 as illustrated in FIGS. 1 and 2. Furthermore, the overturn preventing device 1 includes an informing part 100.

The damper 10 includes a cylinder 11, a rod guide (not illustrated), a piston (not illustrated), a rod 13 and two joints 15 respectively provided at both ends thereof. The cylinder 11 is bottomed and has a cylindrical shape. The rod guide closes an opening of the cylinder 11. The piston is slidably inserted in the cylinder 11. The rod 13 has a proximal end coupled to the piston. The rod 13 is inserted through the rod guide, and a distal end side of the rod 13 protrudes out of the cylinder 11. The cylinder 11 encloses a hydraulic fluid and compressed gas. Each joint 15 is formed by bending a flat plate-shaped metal fitting as illustrated in FIGS. 1 to 3. The joints 15 are respectively connected to a bottom of the cylinder 11 and the distal end of the rod 13. Each joint 15 is formed with a through hole 15A extending therethrough in a direction perpendicular to an axis line of the damper 10.

The damper 10 is a compression damper in which a damping force generated during an extending operation is smaller than a damping force generated during a contracting operation. The extending operation of the damper 10 refers to an operation which increases an amount of protrusion of the rod 13 out of the cylinder 11 and the length of the damper 10. The contracting operation of the damper 10 refers to an operation which reduces an amount of protrusion of the rod 13 out of the cylinder 11 and the length of the damper 10. An expansion force of the compressed gas enclosed in the cylinder 11 works in an extension direction of the damper 10.

The following will describe a mechanism of generating a damping force by the damper 10. Since the mechanism has a known structure, diagrammatic representation is eliminated. The cylinder 11 has an interior divided by the piston into a rod side pressure chamber in which the proximal end of the rod 13 is housed and a counter-rod side pressure chamber. The piston is formed with an orifice which is a throttle valve communicating between both pressure chambers. The orifice functions as a damping force generator which applies resistance to a flow of the hydraulic fluid between the rod side pressure chamber and the counter-rod side pressure chamber with the extending/contracting operation of the damper 10. Furthermore, the piston is formed with a communication path communicating with both pressure chambers via a check valve. The check valve allows the hydraulic fluid to flow from the rod side pressure chamber to the counter-rod side pressure chamber and blocks reverse flow of the hydraulic fluid. Accordingly, the damper 10 has two flow paths of the hydraulic fluid from the rod side pressure chamber to the counter-rod side pressure chamber during the extending operation, that is, one flow path including the orifice and the other flow path including the communication path. On the other hand, the damper 10 has only one flow path of the hydraulic fluid from the counter-rod side pressure chamber to the rod side pressure chamber through the orifice during the contracting operation. Accordingly, the damping force generated by the damper 10 during the extending operation is smaller than the damping force generated by the damper 10 during the contracting operation.

The paired bases 30A and 30B are respectively a first base 30A to which the joint 15 connected to the bottom of the cylinder 11 is coupled and a second base 30B to which the joint 15 connected to a distal end of the rod 13 is coupled, as illustrated in FIGS. 1 and 2. The first base 30A is placed in abutment on the top surface of the furniture F, and the second base 30B abuts against the ceiling C. The first and second bases 30A and 30B have the same form and the same structure. Each of the bases 30A and 30B has a base body 31, a bolt 45 and a nut 47 serving as a rotating shaft member, a bush 35, and a slip preventing part 37, as illustrated in FIGS. 1 to 4.

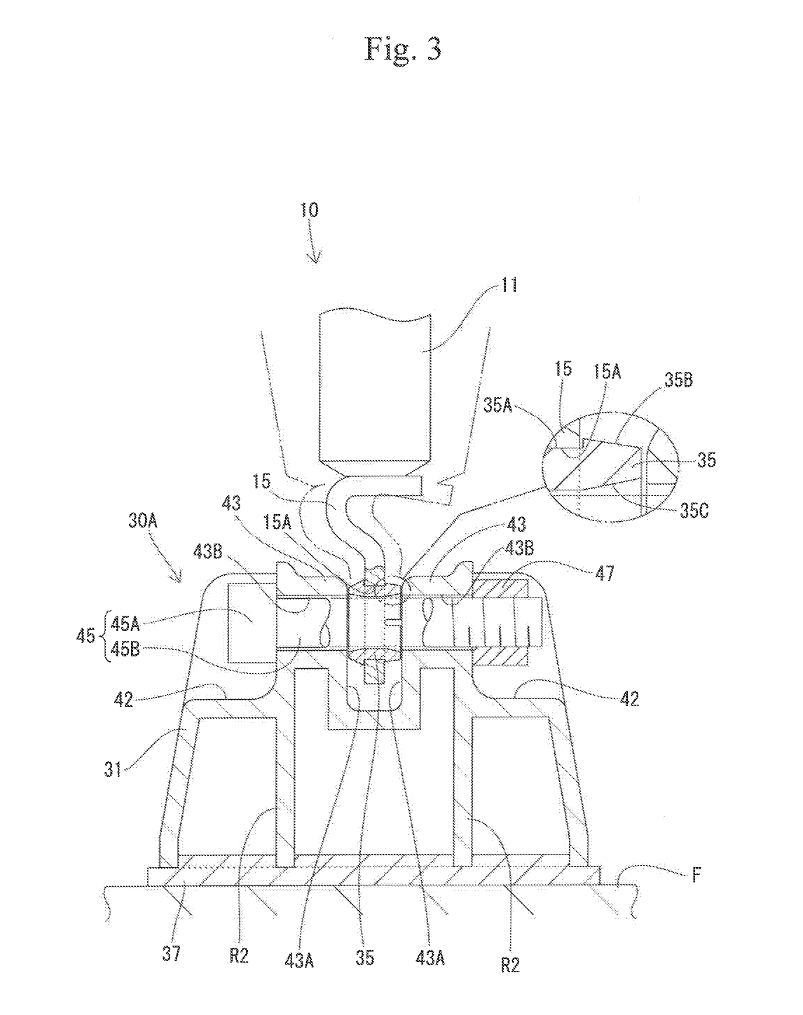

The base body 31 has a rectangular outer shape in a planar view as viewed from above in a state where the first base 30A is placed in abutment on the top surface of the furniture F. Hereinafter, a direction in which a long side in the outer shape of the base body 31 extends in this planar view will be referred to as “a long side direction” and a direction in which a short side extends will be referred to as “a short side direction”. Furthermore, in a side view of the first base 30A as viewed in the short side direction in the state where the first base 30A is placed in abutment on the top surface of the furniture F, the base body 31 has a lower edge which extends straightforward in parallel to the top surface of the furniture F and an upper edge which upwardly bulges from both sides of the lower edge thereby to have an arc-shaped outer shape (refer to FIG. 1). Still furthermore, in a side view of the first base 30A as viewed in the long side direction in the state where the first base 30A is placed in abutment on the top surface of the furniture F, the base body 31 has a trapezoidal outer shape in which the upper edge is shorter than the lower edge (refer to FIGS. 2 and 3).

In the first base 30A placed in abutment on the top surface of the furniture F, the base body 31 has a groove 41 which is formed in an upper surface thereof and extends in the long side direction (a right-left direction as viewed in FIG. 1 and a depthwise direction as viewed in FIGS. 2 and 3). The groove 41 has a bottom 41A spreading on a horizontal surface and inner wall surfaces 41B respectively rising from both sides of the bottom 41A substantially in a vertical direction. The bottom 41A of the groove 41 extends substantially at a middle of the base body 31 in the up-down direction. Furthermore, the bottom 41A of the groove 41 has a constant width except for a portion formed with a pair of convex portions 43 which will be described later.

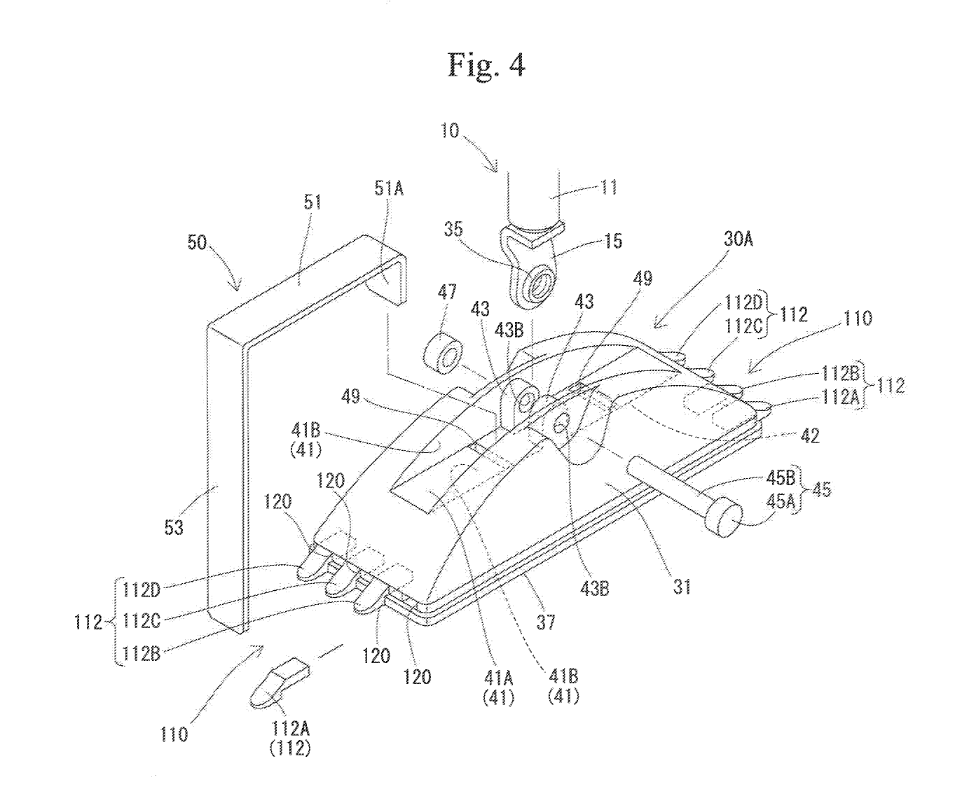

The groove 41 has the paired convex portions 43 which are formed at a central part thereof in the long side direction to protrude from the bottom 41A and both inner wall surfaces 41B of the groove 41, as illustrated in FIG. 4. A space is defined between the convex portions 43 as illustrated in FIGS. 2 and 3. The joint 15 of the damper 10 and a bush 35 which will be described later are fitted into the space. The space communicates with the groove 41. A distance between the inner wall surfaces 43A of the convex portions 43 (a dimension of the space in the short side direction) is slightly longer than a length of the bush 35. The convex portions 43 have respective insertion holes 43B which are formed to extend through upper central parts thereof in the short side direction and through which a shaft part 45B of the bolt 45, which will be described later, is to be inserted.

A pair of locked holes 49 is formed in the bottom 41A of the groove 41 as illustrated in FIG. 4. The locked holes 49 are formed so that respective distances from the convex portions 43 toward both ends of the groove 41 are substantially equal to each other. Each locked hole 49 has the shape of a slit extending over an entire width of the groove 41. In other words, each locked hole 49 has a length equal to the width of the groove 41 and a width that is slightly larger than a thickness of a locking part 51A of the fall preventing part 50 and a thickness of an insertion part 71B provided in the angle regulator 70 which will be described later. One of the locked holes 49 serves as a locked part into which the locking part 51A of the fall preventing part 50 is inserted thereby to be locked. The other locked hole 49 serves as a locked part into which the insertion part 71B provided in the angle regulator 70 is inserted thereby to be locked.

In the first base 30A placed in abutment on the top surface of the furniture F, the base body 31 has recesses 42 respectively formed in both sides of the groove 41 in the middle in the long side direction. The recesses 42 are each open upward and outward with respect to the short side direction. The recesses 42 each have a side in which the insertion hole 43B formed through the convex portion 43 is open. A head 45A of the bolt 45 and the nut 47 screwed onto the bolt 45 which will be described later are respectively disposed in the recesses 42. The recesses 42 are formed to be upwardly spread in the long side direction so that tools can be fitted with the bolt head 45A and the nut 47 from above.

The base body 31 is hollow as illustrated in FIGS. 1 to 3. The base body 31 is downwardly open in the first base 30A placed in abutment on the top surface of the furniture F. The base body 31 has a plurality of ribs R1 formed inside thereof to extend in parallel to the short side direction and two ribs R2 formed inside thereof to extend in parallel to the long side direction so that the ribs R1 and the ribs R2 intersect with each other.

The rotating shaft member includes the bolt 45 inserted from one of the insertion holes 43B of the base body 31 and the nut 47 screwed onto the shaft part 45B of the bolt 45, as illustrated in FIGS. 2 and 3. Central axes of the respective bolts 45 serve as rotation axes of the damper 10 in the bases 30A and 30B.

The bush 35 is substantially cylindrical in shape as illustrated in FIG. 3. The bush 35 has a length that is slightly smaller than a distance between the inner wall surfaces 43A of the paired convex portions 43 provided in the base body 31. The bush 35 is formed with a concave portion 35A going around a central part of the outer peripheral surface thereof. The concave portion 35A has an outer diameter that substantially equals an inner diameter of the through hole 15A formed through the joint 15 of the damper 10. The bush 35 has portions rising from both ends of the concave portion 35A which portions have outer diameters larger than the inner diameter of the through hole 15A of the joint 15. Furthermore, both ends of the bush 35 have respective outer peripheral surfaces 35B the diameters of which are outwardly reduced. As a result, the bush 35 is inserted into the through hole 15A of the joint 15 of the damper 10 while being elastically deformed. The concave portion 35A is then fitted to the through hole 15A so that the bush 35 is attached to the joint 15 of the damper 10.

The central part of the bush 35 has an inner diameter slightly larger than an outer diameter of the shaft part 45B of the bolt 45. Furthermore, both ends of the bush 35 have inner peripheral surfaces 35C the diameters of which are outwardly enlarged. Accordingly, the bush 35 is rotatable about the shaft part 45B of the bolt 45. Furthermore, the bush 35 is inclinable with respect to the shaft part 45B of the bolt 45 to the extent that the inner peripheral surfaces 35C of both ends thereof having enlarged diameters abut against an outer peripheral surface of the shaft part 45B of the bolt 45. In other words, the damper 10 with the bush 35 attached to the joint 15 is rotatable about the shaft part 45B of the bolt 45 and swingable in a direction intersecting the rotation direction. More specifically, the damper 10 can be swung more largely in the direction intersecting the rotation direction due to the dimensional allowance and the enlarged diameters of the inner peripheral surfaces 35C.

The slip preventing part 37 is made of rubber, for example, and has an outer shape which is similar to and slightly larger than the outer shape of the base body 31 (a rectangular shape), and is substantially flat in shape, as illustrated in FIGS. 1 to 4. In the first base 30A placed in abutment on the top surface of the furniture F, the slip preventing part 37 is fitted to a lower opening of the base body 31. In more detail, in the slip preventing part 37, a surface which abuts against the top surface of the furniture F or the ceiling C is flat, and an oppositely directed surface (the surface opposed to the base body 31) is formed with a fitting groove according to an outer peripheral wall of the base body 31 and the ribs R1 and R2. The slip preventing part 37 is detachably attached to the base body 31 by an elastic force thereof.

At the portions where the damper 10 and the bases 30A and 30B are coupled, the bushes 35 are respectively rotatable relative to the shaft parts 45B of the bolts 45 as illustrated in FIG. 3. Both ends of the damper 10 are respectively coupled to the bases 30A and 30B so as to be rotatable about the rotation axes. Both ends of the bush 35 have the inner peripheral surfaces 35C the diameters of which are outwardly enlarged. Accordingly, the bush 35 is inclinable relative to the rotation axis to the extent that the inner peripheral surfaces 35C of both ends thereof having enlarged diameters abut against the outer peripheral surface of the shaft part 45B of the bolt 45. More specifically, the damper 10 can be swung more largely in a direction intersecting the rotation direction due to the dimensional allowance and the enlarged diameters of the inner peripheral surfaces 35C. Thus, the damper 10 coupled to the bases 30A and 30B is swingable in the direction intersecting the rotation direction.

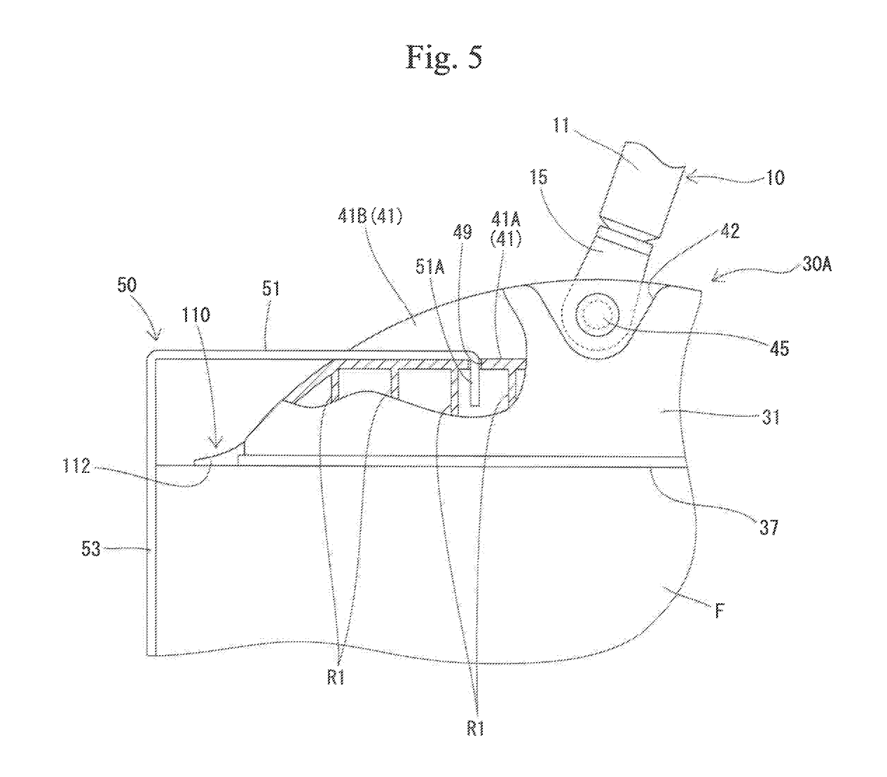

The fall preventing part 50 is formed by bending a flat band-shaped metal, or formed of a resin, and has a coupling part 51 and a drooping part 53, as illustrated in FIGS. 1, 4, and 5. The fall preventing part 50 has a constant width that is slightly smaller than that of the groove 41 formed in the base body 31. The coupling part 51 has a locking part 51A formed by bending one of ends thereof at a right angle. The drooping part 53 is continuous to the other end of the coupling part 51 and perpendicular to the coupling part 51 and extends in the same direction as the locking part 51A. The drooping part 53 has a length set so as not to come out from between the wall surface W and the rear surface of the furniture F when the overturn preventing device 1 falls in such a direction that an upper side thereof departs from the wall surface W. The fall preventing part 50 is attached to the first base 30A placed in abutment on the top surface of the furniture F. The locking part 51A of the coupling part 51 is inserted and locked in the locked hole 49 of the base body 31 located at the wall surface W side. In a state of being attached to the base body 31, the coupling part 51 of the fall preventing part 50 extends along the groove 41 formed in the base body 31 and the other end of the coupling part 51 is located outside an outer edge of the first base 30A (an outer edge of the slip preventing part 37 of the first base 30A). The drooping part 53 droops from the other end of the coupling part 51 and extends downward slightly outside the outer edge of the slip preventing part 37. As illustrated in FIG. 1, the fall preventing part 50 is disposed between the wall surface W and the rear surface of the furniture F below the first base 30A.

The angle regulator 70 is detachably attached to the first base 30A as illustrated in FIGS. 1 and 2. In a state of being attached to the first base 30A, the angle regulator 70 has a regulating part 71 which extends substantially vertically, and a support part 73 which is provided to be continuous from a lower part of the regulating part 71 and prevents the regulating part 71 from being inclined. The regulating part 71 is a flat plate and is substantially rectangular in shape. When the angle regulator 70 is attached to the first base 30A placed in abutment on the top surface of the furniture F, one of short side ends of the regulating part 71 serves as a receiving part 71A located at an upper end. And, the other short side end is located at a lower end and serves as the insertion part 71B which is inserted into the locked hole 49 of the base body 31 located at the side away from the wall surface W. The regulating part 71 causes the cylinder 11 of the damper 10 to abut against the receiving part 71A thereby regulating the damper 10 so as not to fall in excess of the inclined state. An inclination angle of the damper 10 preferably ranges from 15° to 25° with respect to the vertical direction. The receiving part 71A is upwardly open and curved so as to be downwardly recessed at a central part thereof so that about one third of the outer periphery of the cylinder 11 abuts thereagainst. Since the cylinder 11 is not held tightly by the receiving part 71A, the movement of the damper 10 is not restrained when the furniture F is tilted or shaken by shaking of an earthquake or the like.

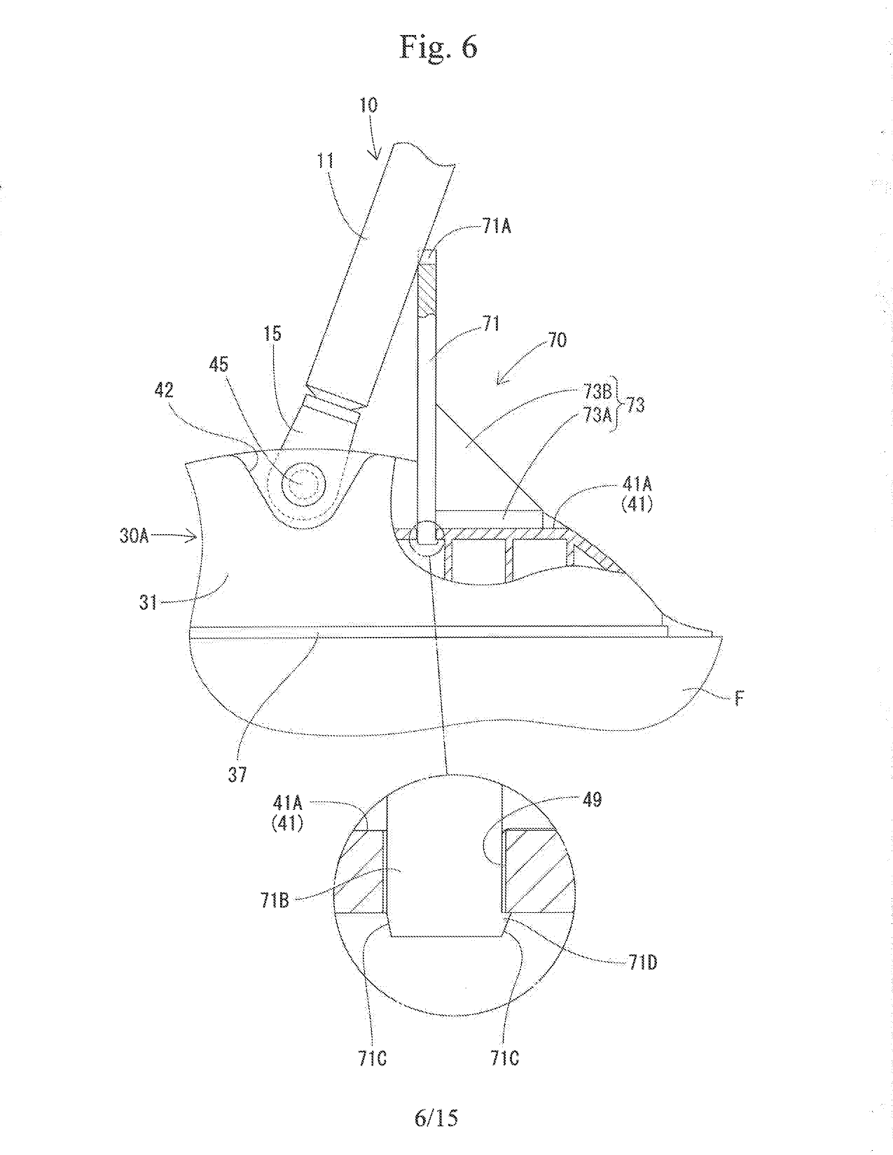

The insertion part 71B has inclined surfaces 71C respectively formed by cutting out both side corners of the short side in the long side direction so as to become thinner toward a distal end thereof, and a protrusion 71D protruding from one of sides of the distal end in the short side direction, as illustrated in FIG. 6. The support part 73 includes a first support part 73A and a second support part 73B. The first support part 73A has the same width as the regulating part 71 and is a flat plate extending in a direction perpendicular to the regulating part 71. The first support part 73A abuts against the bottom 41A of the groove 41 formed in the base body 31 when the insertion part 71B of the regulating part 71 is inserted into the locked hole 49 of the base body 31 of the first base 30A. The second support part 73B is a flat plate which has an isosceles right triangle shape and is coupled to a corner between the first support part 73A and the regulating part 71.

Next, the informing parts will be described.

The overturn preventing device 1 includes the informing part which performs when the base 30A or 30B is subjected to a predetermined load. In the example as illustrated in FIG. 1 and the like, the informing part is constituted by a shape-changeable part 110. The shape-changeable part 110 is a part which changes its shape when the base 30A or 30B is subjected to the predetermined load. The predetermined load means a load that changes the shape of the shape-changeable part 110.

In the example as illustrated in FIG. 1 and the like, the bases 30A and 30B have the same construction, and the shape-changeable parts 110 provided on respective bases also have the same construction. Hence, the shape-changeable part 110 provided on the first base 30A will be mainly described in the following description, and a detailed description of the shape-changeable part 110 provided on the second base 30B will be eliminated by regarding it as having the same configuration and the same function.

As illustrated in FIG. 4, the shape-changeable part 110 is constituted by a plurality of protrusions 112 arranged on the peripheral edge of the first base 30A to extend outward. In the example as illustrated in FIG. 4, the base body 31 of the base 30A is formed into an elongate shape long in a predetermined direction (the aforementioned long side direction), and a set of four protrusions 112 is provided at each of two longitudinal ends of the base body 31. The set of four protrusions 112 is constituted of a first protrusion 112A, a second protrusion 112B, a third protrusion 112C and a fourth protrusion 112D.

As illustrated in FIG. 4, the first to fourth protrusions 112A to 112D provided on each end of the base body 31 are arranged at intervals along the peripheral edge of the base body 31. In each set, the first to fourth protrusions 112A to 112D are arranged at regular intervals in the short side direction of the base body 31 (the lateral direction).

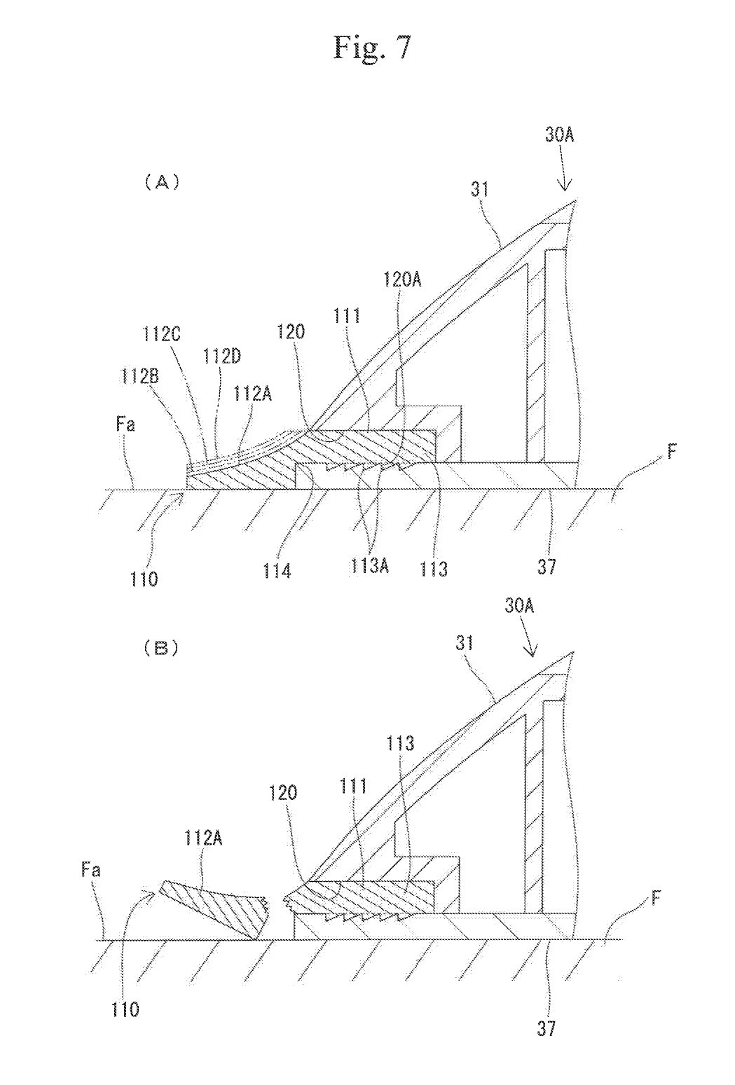

Each protrusion 112 provided in the first base 30A is made of a resin material and coupled to the base body 31. Each protrusion 112 is disposed to protrude outside the peripheral edge of the base body 31 (more specifically, longitudinally outside the base body 31). Furthermore, each protrusion 112 faces an installation target surface and extends along the installation target surface, as illustrated in FIG. 7(A). In the example of FIG. 7(A), each protrusion extends in a structure such that a thickness thereof is reduced as coming closer to the distal end side thereof.

The installation target surface which the protrusion 112 faces is the top surface of the article or the ceiling. In the example of FIG. 7(A), the top surface Fa of the furniture F serves as the installation target surface. For example, when the overturn preventing device 1 is mounted between the ceiling C and the furniture F as illustrated in FIG. 1, the protrusion 112 is disposed in contact with the top surface Fa of the furniture F. Although FIG. 7(A) illustrates an example in which the lower surface of the protrusion 112 is in contact with the top surface Fa of the furniture F, the protrusion 112 may be mounted so that the lower surface thereof is in proximity to the top surface Fa of the furniture F without being in contact with the top surface Fa.

Each protrusion 112 has a recess 114 which is formed at the installation target surface side or at an opposite side of the installation target surface in order to locally reduce the thickness thereof. The recess 114 is formed in a proximal end of the protrusion 112. The recess 114 is formed into such a groove shape as to extend over an entire width direction of the protrusion 112 perpendicular to a protruding direction. When, for example, force is applied to the protrusion 112 so that the distal end side of the protrusion 112 is deformed so as to be bent, breakage easily occurs near the recess 114 since the stress concentrates on the recess 114.

As illustrated in FIGS. 4 and 7(A), each protrusion 112 is formed as a member independent of the base body 31. On the other hand, the base body 31 of the base 30A is formed with mounting holes 120 provided for mounting the protrusions 112. The mounting holes 120 are an example of a mounting portion.

In the example of FIG. 7(A), an attaching member 111 independent of the base body 31 is provided. The attaching member 111 is formed with the aforementioned protrusion 112 and an insertion portion 113. The insertion portion 113, which is a part of the attaching member 111, is fitted in the mounting hole 120 while being inserted in the mounting hole 120. The insertion portion 113 is formed with claws 113A serving as a locking part. The claws 113A are locked while being caught on a concave portion 120A serving as a locked part formed in the mounting hole 120. Although the attaching member 111 is thus retained, the structure should not be limited to this as long as the structure can prevent the attaching member 111 from coming out of the mounting hole 120.

In the shape-changeable part 110 as illustrated in FIG. 4, the protrusions 112A to 112D arranged on the end of the base body 31 have respective different breaking strengths. More specifically, the first to fourth protrusions 112A to 112D are different in the tensile force for causing breakage when the protrusions 112A to 112D are pulled in the protruding direction. Furthermore, the first to fourth protrusions 112A to 112D are different in the force for starting plastic deformation when the force is applied to the respective distal ends of the protrusions 112A to 112D in the upward direction perpendicular to the protruding direction.

More specifically, the first to fourth protrusions 112A to 112D each have a different thickness at the recess 114 (a minimum distance between an inner surface of the recess 114 and an upper surface of the protrusion 112). FIG. 7(A) illustrates a cross section cut at the position of the first protrusion 112A, and outer edge configurations of the second to fourth protrusions 112B to 112D are illustrated by two-dot chain line. As illustrated in FIG. 7(A), the first protrusion 112A has a smallest thickness at the recess 114 and the second protrusion 112B has a second smallest thickness. The third protrusion 112C has a larger thickness at the recess 114 than the second protrusion 112B, and the fourth protrusion 112D has a larger thickness at the recess 114 than the third protrusion 112C.

The overturn preventing device 1 thus constructed is mounted between the furniture F and the ceiling C as illustrated in FIG. 1 thereby to function to prevent the furniture F from overturn in the manner as described above. In the state where the overturn preventing device 1 has been thus installed, when an intense shaking is caused by an earthquake or the like so that the base 30A or 30B is subjected to such a great load as to deform the protrusions 112, the protrusions 112 the number of which depends upon a degree of the load are deformed into a state according to the degree of the load. For example, when shaking or load of the base is great, the protrusion 112 is deformed such that breakage is caused as illustrated in FIG. 7(B). Or, when load is repeatedly applied to the base 30A or 30B with the result that damage or deterioration each of which is so great as to deform the protrusions 112 is caused in the base 30A or 30B, the protrusions 112 the number of which depends upon a degree of the repetition are deformed into a state according to the degree of the repetition. Thus, since the protrusions 112 the number of which depends upon the load or the degree of the repetition are deformed into the state according to the load, the user can estimate how much load has occurred on the overturn preventing device 1 or how much deterioration or damage has occurred in the overturn preventing device 1.

As described above, the overturn preventing device 1 includes the informing part which informs in a case where the base 30A or 30B has been subjected to the predetermined load. Hence, it is possible to inform the user of the fact that the base 30A or 30B has been subjected to the predetermined load after the overturn preventing device 1 has been installed between the article (the furniture F) and the ceiling. Consequently, the user can understand presence or absence of the predetermined load applied to the base 30A or 30B, so that the deterioration or damage caused by the load can be likely to be left.

In the overturn preventing device 1, the informing part is constituted by the shape-changeable part 110 which changes the shape thereof when the base 30A or 30B has been subjected to the predetermined load. As a result, when the base 30A or 30B has been subjected to the predetermined load, the fact can be informed to the user by the change in the shape of the shape-changeable part 110. In particular, it is possible to inform of the fact that the predetermined load has occurred by a simple configuration without complicated detection or control.

The shape-changeable part 110 includes the protrusion 112 disposed on the peripheral edge of the base 30A or 30B to extend outward. When such protrusion 112 is provided on the peripheral edge of the base 30A or 30B, deformation or breakage can be easily caused in the protrusion 112 when the overturn preventing device is subjected to an intense fluctuating load in the occurrence of an earthquake or the like or when the overturn preventing device is repeatedly subjected to a fluctuating load. In particular, the protrusion 112 can be selectively deformed or broken easily, while the function of the base is maintained. By such deformation or breakage of the protrusion 112, it is possible to inform of the fact that the predetermined load has been applied to the base.

In the overturn preventing device 1 as illustrated in FIG. 1 and the like, a plurality of protrusions 112 are provided on the peripheral edge of the base 30A or 30B. For example, when a plurality of the protrusions 112 are provided on the peripheral edge of the first base 30A, the protrusions 112 tend to show changes according to the degree of the load applied to the base 30A. For example, the number of the protrusions 112 deformed or broken tends to be increased as the fluctuating load applied to the first base 30A becomes large. Furthermore, the number of the protrusions 112 deformed or broken also tends to be increased as the number of times of occurrence of the fluctuating load applied to the first base 30A is increased. In other words, it is possible to inform of the degree of deterioration or damage of the first base 30A by the number of protrusions 112 deformed or broken. The same effect can be achieved with respect to the second base 30B, too.

The overturn preventing device 1 as illustrated in FIG. 1 and the like is provided with a plurality of types of protrusions 112 having different breaking strengths. For example, when the first base 30A is provided with a plurality of types of protrusions 112 having different breaking strengths, the number of types of protrusions 112 deformed or broken is reduced as the degree (magnitude or the number of occurrence) of the fluctuating load applied to the first base 30A is small, and the number of types of protrusions 112 deformed or broken is increased as the degree (magnitude or the number of occurrence) of the fluctuating load applied to the first base 30A is large. As being thus configured, the protrusions 112 tend to show the changes in the positions and the number more accurately reflecting the degree of the fluctuating load applied to the first base 30A. Therefore, it is possible to inform of the degree of deterioration of the first base 30A more accurately by the positions or the number of the protrusions 112 deformed or broken. The same effect can be achieved with respect to the second base 30B, too.

In the overturn preventing device 1 as illustrated in FIG. 1 and the like, the protrusion 112 is independent of the base body 31 (body) of the base 30A or 30B. The base body 31 is provided with the mounting hole 120 (mounting portion) for mounting the protrusion 112. When the protrusion 112 and the base body 31 are thus constructed, the protrusion 112 can be attached to the base body 31 at a desired time. For example, the protrusions 112 can be attached to the base 30A or 30B after the first base 30A has been installed so as to abut against the article or after the second base 30B has been installed so as to abut against the ceiling. Consequently, the protrusion 112 is less likely to be erroneously damaged at the time of installation of the base 30A or 30B, with the result that it is possible to inform of load change after installation of the overturn preventing device 1 more accurately.

In the overturn preventing device 1, the shape-changeable parts 110 functioning as the informing part is provided also on the base at the ceiling side (the second base 30B). When the shape-changeable parts 110 is thus provided on the ceiling-side base, the shape-changeable part 110 can be rendered more visible, so that the user can more easily understand the information contents. For example, the shape-changeable part 110 can be looked up at for visual recognition at a position not hidden by the article, so that the user can more easily determine whether or not the shape-changeable part 110 has changed its shape.

### Second Embodiment

The overturn preventing device 201 of a second embodiment will be described.

The overturn preventing device 201 of the second embodiment differs from the overturn preventing device 1 of the first embodiment only in that a first base 230A is provided instead of the first base 30A and that a second base (not illustrated) having the similar construction to that of the first base 230A is provided instead of the second base 30B. The overturn preventing device 201 is the same as the overturn preventing device 1 of the first embodiment in the other respects. The first base 230A differs from the first base 30A of the first embodiment only in that the base body 231 is provided instead of the base body 31 and that integrally formed protrusions 212 are provided instead of the attaching member 111. The base body 231 differs from the base body 31 in that no mounting holes 120 are provided and that the base body 231 is coupled to the protrusions 212. The base body 231 is the same as the base body 31 in the other respects.

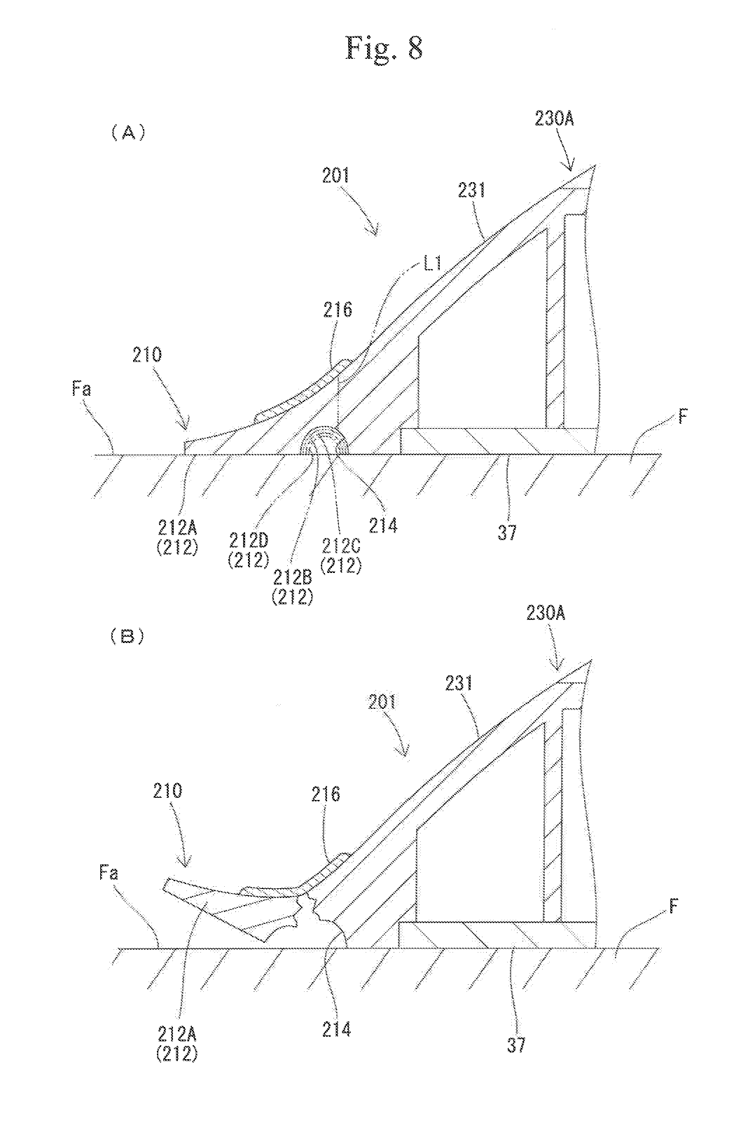

In the overturn preventing device 201 as illustrated in FIGS. 8(A) and 8(B), the informing part is constituted by the shape-changeable part 210. The informing part 210 changes the shape thereof when the first base 230A has been subjected to such load as to change the shape of the shape-changeable part 210.

In this configuration, the protrusions 212 as illustrated in FIGS. 8(A) and 8(B) are provided integrally with the base body 231 at the positions of the protrusions 112 as illustrated in FIG. 4, instead of the protrusions 112. The protrusions 212 are arranged on the peripheral edge of the first base 230A so as to extend outward from the base body 231. More specifically, the base body 231 is formed into the elongate shape long in the predetermined direction (the aforementioned long-side direction), and two sets protrusions 212, each of which sets includes four protrusions 212, are respectively provided on both longitudinal ends of the base body 231. Four protrusions 212 provided on each end are arranged in the same manner as each set of protrusions 112 as illustrated in FIG. 4.

Each protrusion 212 provided on the first base 230A is made of the resin material and coupled integrally to the base body 231. In FIG. 8(A), two-dot chain line L1 indicates the position of the peripheral edge of the base body 231 (the coupling locations of the protrusions 212). The protrusions 212 are arranged to protrude outside the peripheral edge of the base body 231 (more specifically, longitudinally outside the base body 231).

Each protrusion 212 faces the top surface Fa of the furniture F serving as the installation target surface and extends along the top surface Fa, as illustrated in FIG. 8(A). For example, when the overturn preventing device 201 is mounted between the ceiling C and the furniture F in the same mounted state as in FIG. 1, the protrusions 212 are disposed in contact with the top surface Fa of the furniture F. Although FIG. 8(A) illustrates an example in which the lower surface of the protrusion 212 is in contact with the top surface Fa of the furniture F, the protrusion 212 may be mounted so that the lower surface thereof is in proximity to the top surface Fa of the furniture F without being in contact with the top surface Fa.

Each protrusion 212 has a recess 214 which is formed at the installation target surface side or at an opposite side of the installation target surface in order to locally reduce the thickness thereof. In the example of FIG. 8(A), the recess 214 is formed in the proximal end and the lower surface part of the protrusion 212 so as to be recessed upward. The recess 214 is formed into such a groove shape as to extend over an entire width direction of the protrusion 212 perpendicular to a protruding direction. When, for example, force is applied to the protrusion 212 so that the distal end side of the protrusion 212 is deformed so as to be bent, breakage easily occurs near recess 214 since the stress concentrates on the recess 214.

In the shape-changeable part 210 as illustrated in FIGS. 8(A) and 8(B), too, four protrusions 212 made into one set (the set having the same arrangement of four protrusions 112 as illustrated in FIG. 4) and arranged on each end of the base body 231 have respective different breaking strengths. In this example, too, the protrusions 212 each have a different thickness at the recess 214 (a minimum distance between an inner surface of the recesses 214 and an upper surface of the protrusion 212). FIG. 8(A) illustrates a cross section cut at the position of the first protrusion 212A in the set of four protrusions 212 provided on one of ends of the base body 231. Two-dot chain line indicates inner surface configurations of the recesses of the second to fourth protrusions 212B to 212D. The recess 214 of the first protrusion 212A is the deepest, and the recesses 214 become deeper in the order of the second, third and fourth protrusions 212B, 212C and 212D. As illustrated in FIG. 8(A), the thickness at the recess 214 in the first protrusion 212A is the smallest, and the thickness at the recess 214 in the second protrusion 212B is the second smallest. The thickness at the recess 214 in the third protrusion 212C is larger than that in the second protrusion 212B, and the thickness at the recess 214 in the fourth protrusion 212D is larger than that in the third protrusion 212C.

Furthermore, in this configuration, the protrusion 212 and the base body 231 (body) are bonded together by a bonding layer 216. More specifically, the bonding layer 216 is bonded on a surface opposed to the recesses 214 so as to extend over the protrusion 212 and the base body 231.

According to this configuration, even when a fluctuating load is applied to the first base 230A with the result that the protrusion 212 is broken as illustrated in FIG. 8(A), the broken piece of the protrusion 212 remains coupled to the base body 231 by the bonding layer 216. Therefore, while the breakage of the protrusion 212 can inform of occurrence of load, the broken piece of the protrusion 212 can be less likely to be scattered after breakage.

The configuration of providing the bonding layer 216 over the base body and the protrusion may be applied to the construction of the above-described first embodiment and the constructions of third and fourth embodiments which will be described later.

### Third Embodiment

Next, the overturn preventing device of a third embodiment will be described.

The overturn preventing device 301 of the third embodiment differs from the overturn preventing device 1 of the first embodiment only in that a first base 330A is provided instead of the first base 30A and that a second base (not illustrated) having the similar construction to that of the first base 330A is provided instead of the second base 30B. The overturn preventing device 301 is the same as the overturn preventing device 1 of the first embodiment in the other respects. The first base 330A differs from the first base 30A of the first embodiment only in that the base body 331 is provided instead of the base body 31 and that an attaching member 311 is provided instead of the attaching member 111.

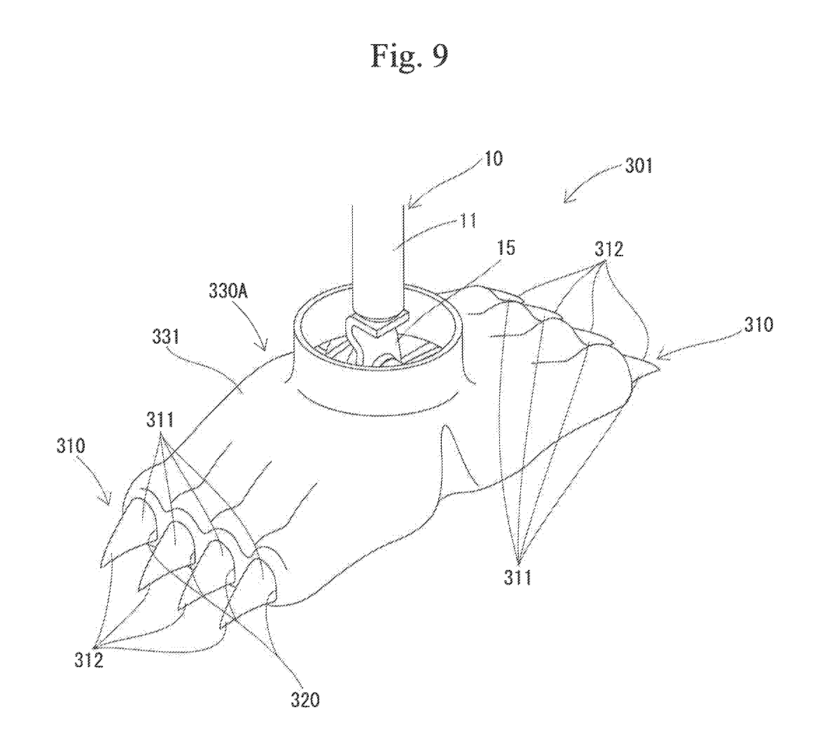

In the example of FIG. 9, the first base 330A is constituted as a design part imitating a part of a character or an animal. More specifically, the base body 331 is formed into a shape imitating a foot of a character or an animal (for example, a foot of a monster character), and the protrusions 312 are formed into a shape imitating claws of the character or the animal. Although design is eliminated in the damper 10, a design part may be provided around the damper 10 so as to be continuous from the base body 331.

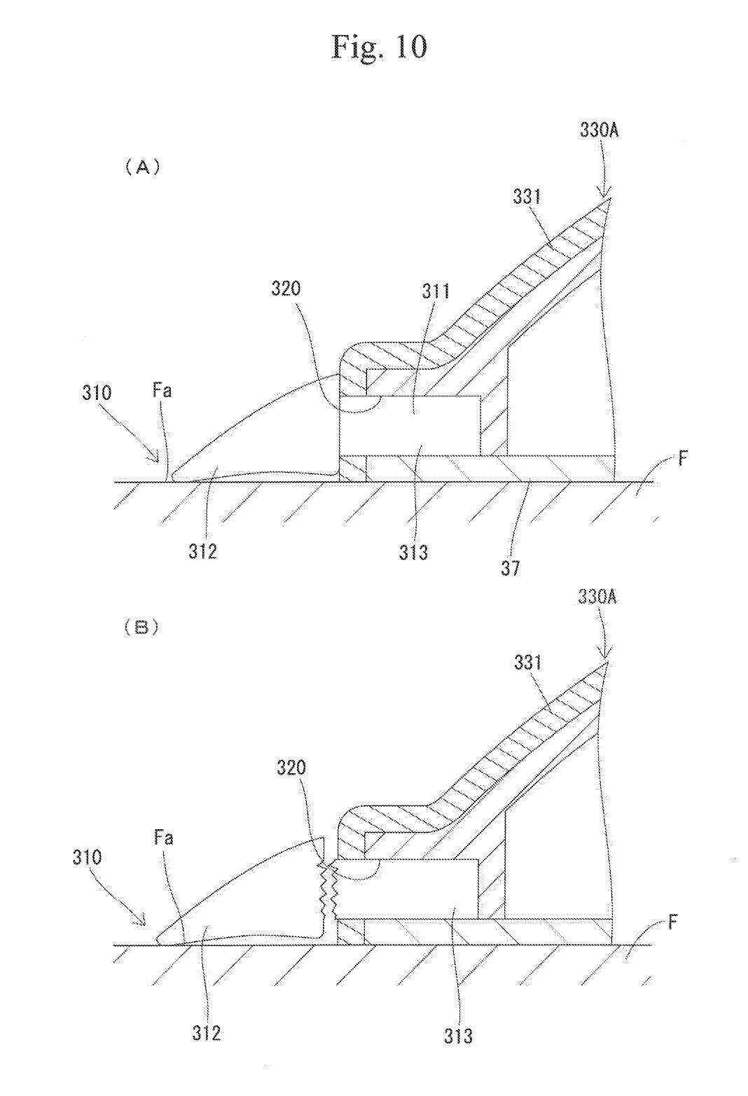

As illustrated in FIG. 9, the shape-changeable part 310 is constituted by a plurality of protrusions 312 arranged on the peripheral edge of the first base 330A to extend outward. The base body 331 is formed into an elongate shape long in the predetermined direction, and two sets of protrusions 312, each of which sets includes four protrusions 312, are respectively provided on both longitudinal ends of the base body 331. Four protrusions 312 of each set are arranged at intervals along the peripheral edge of the base body 331. Each protrusion 312 provided in the first base 330A is made of a resin material and coupled to the base body 331. Each protrusion 312 is disposed to protrude outside the peripheral edge of the base body 331 (more specifically, longitudinally outside the base body 331). Furthermore, each protrusion 312 faces the top surface Fa of the furniture F serving as the installation target surface and extends along the installation target surface, as illustrated in FIG. 10(A). In the example of FIG. 10(A), each protrusion 312 extends in a structure such that a thickness thereof is reduced as coming closer to the distal end side thereof.

As illustrated in FIG. 10(A), each protrusion 312 is formed as a member independent of the base body 331. On the other hand, the base body 331 of the base 330A is formed with mounting holes 320 respectively provided for mounting the protrusions 312. The mounting holes 320 are an example of a mounting portion. More specifically, the attaching member 311 independent of the base body 331 is formed with the aforementioned protrusion 312 and an insertion portion 313 which has a smaller outer diameter or thickness than the proximal end of the protrusion 312. The insertion portion 313, which is a part of the attaching member 311, is fitted in the mounting hole 320 while being inserted in the mounting hole 320, so that the protrusion 312 and the base body 331 are coupled to each other.

The above-described constructions can also achieve the same action and effect as that of the first embodiment. When shaking or load of the base is large, the protrusions 312 are deformed such that breakage occurs as illustrated in FIG. 10(B).

In this configuration, too, in the shape-changeable part 310 as illustrated in FIG. 9, four protrusions 312 made into one set and arranged on each end of the base body 331 may have respective different breaking strengths. More specifically, the protrusions 312 may be configured to be different in the tensile force for causing breakage when pulled in the protruding direction. Alternatively, the protrusions 312 may be configured to be different in the force for starting plastic deformation when the force is applied to the respective distal ends of the protrusions 312 in the upward direction perpendicular to the protruding direction. For example, such an effect can be achieved by constructing the connecting part of the insertion part 313 with the protrusion 312 to have a different diameter or thickness in each attaching member 311.

### Fourth Embodiment

Next, the overturn preventing device 401 of a fourth embodiment will be described.

The overturn preventing device 401 of the fourth embodiment differs from the overturn preventing device 1 of the first embodiment only in that a first base 430A is provided instead of the first base 30A and that a second base (not illustrated) having the similar construction to that of the first base 430A is provided instead of the second base 30B. The overturn preventing device 401 is the same as the overturn preventing device 1 of the first embodiment in the other respects. The first base 430A differs from the first base 30A of the first embodiment only in that the base body 431 is provided instead of the base body 31 and that an attaching member 411 is provided instead of the attaching member 111.

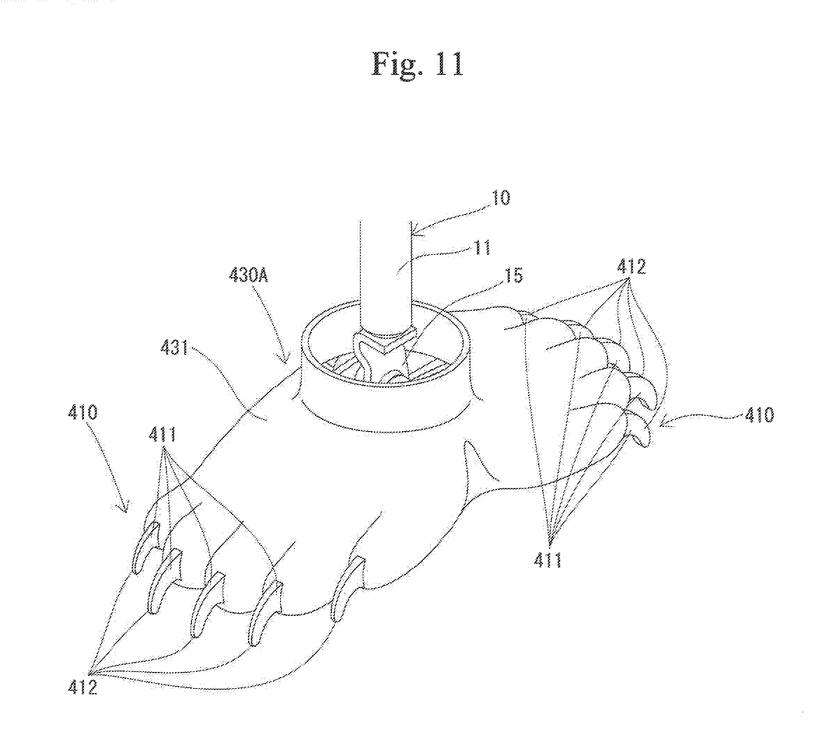

In the example of FIG. 11, too, the first base 430A is constituted as a design part imitating a part of a character or an animal. More specifically, the first base 330A is formed into a shape imitating a foot of an animal (a foot of a mammalian such as bear, tiger, monkey or dog), and the protrusions 412 are formed into a shape imitating claws of the animal.

As illustrated in FIG. 11, the shape-changeable part is constituted by a plurality of protrusions 412 arranged on the peripheral edge of the first base 430A to extend outward. The base body 431 is formed into an elongate shape long in the predetermined direction, and two sets of protrusions 412, each of which sets includes five protrusions 412, are respectively provided on both longitudinal ends of the base body 431. Five protrusions 412 of each set are arranged at intervals along the peripheral edge of the base body 431. Each protrusion 412 provided in the first base 430A is also made of a resin material and coupled to the base body 431. Each protrusion 412 is disposed to protrude outside the peripheral edge of the base body 431 (more specifically, longitudinally outside the base body 431). The protrusions 412 may be formed as members independent of the base body 431 as in the first embodiment or may be formed integrally with the base body 431 as in the second embodiment. Furthermore, each protrusion 412 may be formed with a stress concentration part such as a recess so that breakage or deformation easily occurs. The overturn preventing device 401 of the fifth embodiment can also achieve the same advantageous effects as the first embodiment.

### Fifth Embodiment

Next, the overturn preventing device 501 of a fifth embodiment will be described.

The overturn preventing device 501 of the fifth embodiment differs from the overturn preventing device 1 of the first embodiment only in that a first base 530A is provided instead of the first base 30A and that a second base (not illustrated) having the similar construction to that of the first base 530A is provided instead of the second base 30B. The overturn preventing device 501 is the same as the overturn preventing device 1 of the first embodiment in the other respects. The first base 530A differs from the first base 30A of the first embodiment only in that the base body 531 is provided instead of the base body 31, that the attaching member 111 is eliminated, that a pressure-sensitive sheet 512 is provided, and that the slip preventing part 537 is made of a transparent member. In the overturn preventing device 501, the parts having the same construction as the first embodiment are labeled by the same reference symbols as those of the overturn preventing device 1 as illustrated in FIG. 1, and the detailed description of these parts will be eliminated.

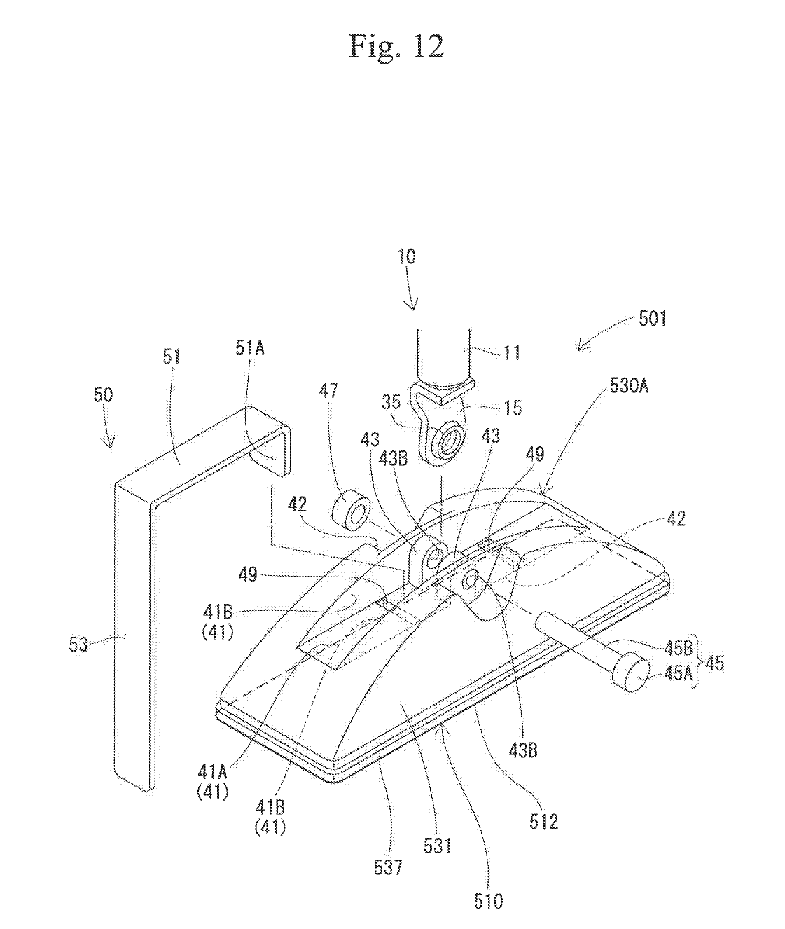

The overturn preventing device 501 includes the informing part which informs in a case where the first base 530A is subjected to a predetermined load. In the example as illustrated in FIG. 12, the informing part is constituted by a display-changeable part 510. The display-changeable part 510 is a part which changes its display when the first base 530A is subjected to the predetermined load. The predetermined load means a load that changes the display of the display-changeable part 510 and more specifically, a load that changes a color of the pressure-sensitive sheet 512 after installation of the overturn preventing device 501.

In the overturn preventing device 501 as illustrated in FIG. 12, the base body 531 differs from the base body 31 of the first embodiment only in that the entire base body is made as the transparent member and that the part of the mounting holes 120 (FIG. 4 and the like) is closed. The base body 531 has the same construction as the base body 31 of the first embodiment in the other respects.

The slip preventing part 537 differs from the slip preventing part 37 (FIG. 4 and the like) of the first embodiment only in that the slip preventing part 537 is made as the transparent member. The slip preventing part 537 has the same construction as the slip preventing part 37 in the other respects. The slip preventing part 537 is configured to allow light to pass therethrough from the upper surface side to the lower surface side.

The display-changeable part 510 has the pressure-sensitive sheet 512 which changes its color when the first base 530A is subjected to the predetermined load. The pressure-sensitive sheet 512 is constituted by a pressure sensitive film, a pressure sensitive paper or the like, each of which changes the color of a part thereof subjected to the pressure into the color corresponding to a magnitude of the pressure. The pressure-sensitive sheet 512 is disposed to cover part or entire of the lower surface of the slip preventing part 537 (the side in contact with the article) and disposed in contact with the article when the overturn preventing device 501 is installed. Since the slip preventing part 537 and the base body 531 both provided at the upper side of the pressure-sensitive sheet 512 are made as the transparent members, the pressure-sensitive sheet 512 is visible from outside via the base body 531 and the slip preventing part 537.

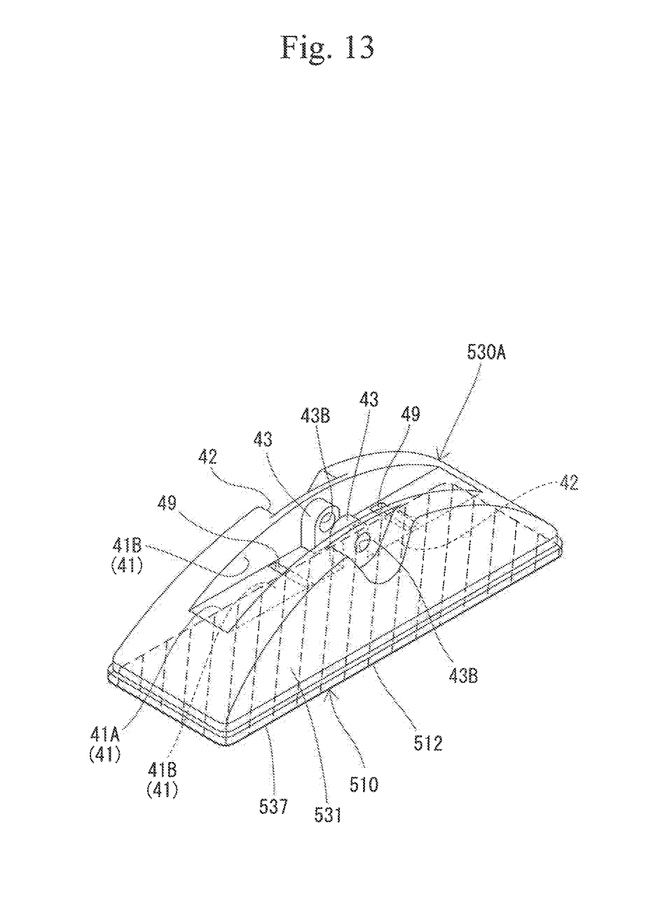

The overturn preventing device 501 thus constructed is mounted between the furniture F and the ceiling C in the same manner as illustrated in FIG. 1 thereby to act to prevent the furniture F from overturn. In the state where the overturn preventing device 501 has been thus installed, when an intense shaking is caused by an earthquake or the like so that the lower surface of the first base 530A is subjected to such a great load as to change the color of the pressure-sensitive sheet 512, the pressure-sensitive sheet 512 changes its color into the color according to the degree of the load, as illustrated in FIG. 13. Thus, when color change according to the degree of the load has occurred in the pressure-sensitive sheet 512, it is possible to grasp the color change from the outside via the transparent base body 531 and slip preventing part 537. As a result, the user can estimate how much load has occurred on the overturn preventing device 501 or how much deterioration or damage has occurred in the overturn preventing device 501.

As described above, the informing part is constituted by the display-changeable part 510 which changes its display when the base has been subjected to the predetermined load. When the informing part is thus configured, it is possible to visually inform the user that the base has been subjected to the predetermined load by the change in the display of the display-changeable part 510.

The display-changeable part 510 is constituted by the pressure-sensitive sheet 512 which changes its color when the base has been subjected to the predetermined load. According to the configuration, it is possible to inform that the base has been subjected to the predetermined load by the change in the color of the pressure-sensitive sheet. Moreover, since it is possible to inform by the sheet material, the informing part can be provided while suppressing the installation space.

The pressure-sensitive sheet 512 can be located at any position where the pressure-sensitive sheet 512 can receive the force from the article. For example, the pressure-sensitive sheet 512 may be located inside the slip preventing part 537.

### Sixth Embodiment

Next, the overturn preventing device 601 of a sixth embodiment will be described.

The overturn preventing device 601 of the sixth embodiment differs from the overturn preventing device 1 of the first embodiment only in that a first base 630A is provided instead of the first base 30A and that a second base (not illustrated) having the similar construction to that of the first base 630A is provided instead of the second base 30B. The overturn preventing device 601 is the same as the overturn preventing device 1 of the first embodiment in the other respects. More specifically, the pressure-sensitive sheet 512 as illustrated in FIG. 12 and the like is eliminated, and a sensor 612, a control 613 and a display 614 are provided in the overturn preventing device 601 of the sixth embodiment. The base body 631 and the slip preventing part 637 are made of the non-transparent material. The overturn preventing device 601 differs from the overturn preventing device 501 of the fifth embodiment only in these respects and is the same as the overturn preventing device 501 in the other respects.

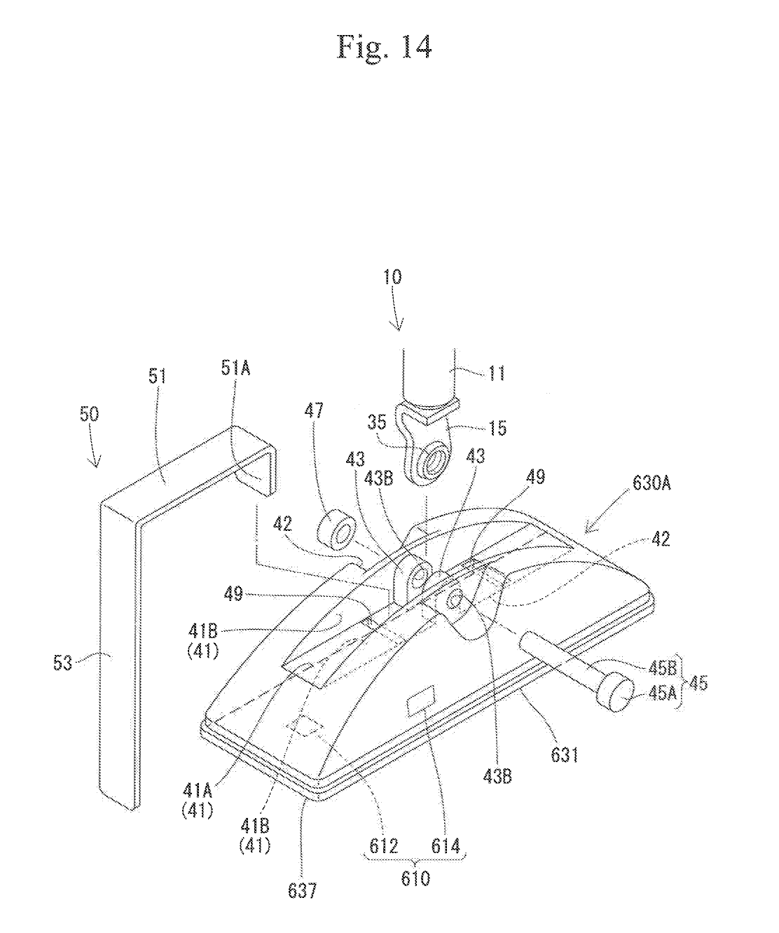

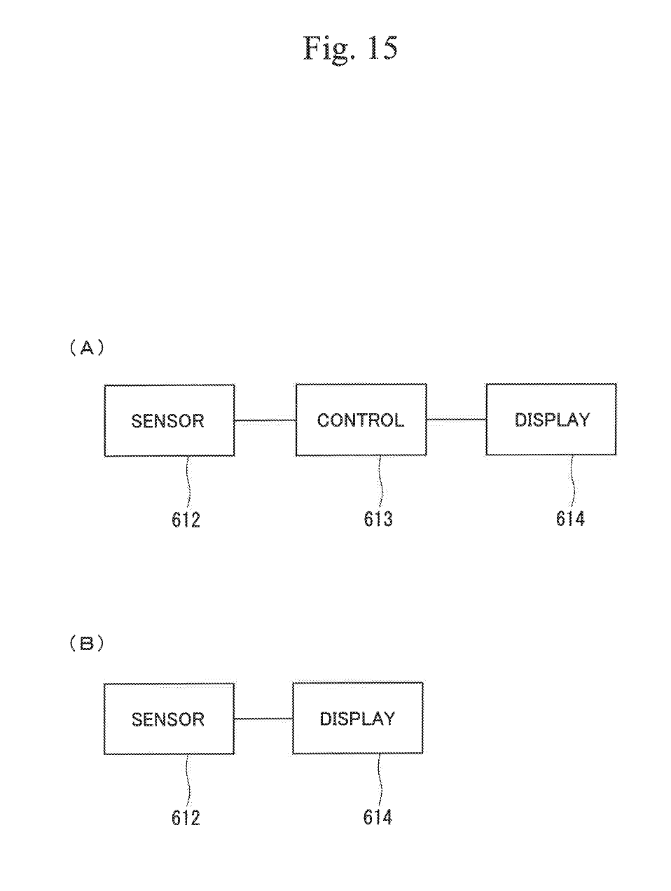

As illustrated in FIG. 14 and FIG. 15(A), the display-changeable part 610 includes the sensor 612 (a detecting part) which detects pressure or strain caused in the first base and the display 614 which displays a result of detection result by the sensor 612.

The sensor 612 is constituted by a known pressure sensor, strain sensor or the like and is provided on the lower surface part of the slip preventing part 637, for example. The sensor 612 is disposed in contact with or in proximity to the top surface of the article serving as the installation target surface in the installed state of the overturn preventing device 601.

The display 614 may be constituted as a lamp such as an LED lamp or a monitor such as a liquid crystal display. For example, when the sensor 612 is constituted as the pressure sensor or the strain sensor, a value (a pressure value or strain value) detected by the sensor 612 is input to the control 613. The control 613 is constituted as, for example, a drive circuit which activates the display 614 when the detected value of the sensor 612 is not less than a predetermined threshold and which does not activate the display 614 when the detected value is less than the predetermined threshold. The control 613 may be constituted by a microcomputer and the like, or as a simplified hardware circuit. In the arrangement as illustrated in FIG. 15(A), a power supply such as a dry-cell battery, a secondary battery or a solar cell is provided separately.

For example, the control 613 operates such that the display 614 emits light when the detected value equal to or above the threshold has been input from the sensor 612 to the control 613. Emission of light in the display 614 by the control 613 may be carried out continuously for a predetermined time or may be carried out at regular intervals.

According to this configuration, the state of the pressure caused in the base can be displayed by the display 614. The user can easily take an appropriate measure against the overturn preventing device 601 by visually recognizing the result of detection displayed on the display 614.

The control 613 may change the display state of the display 614 according to the detection value (the pressure value) input from the sensor 612. For example, the control 613 may control the display 614 such that the display 614 emits light in a first color when the detection value from the sensor 612 is in a first range, and the display 614 emits light in a second color when the detection value is in a second range larger than the first range, and the display 614 emits light in a third color when the detection value is in a third range larger than the second range.

The sensor 612 can be located at any position where the sensor 612 can receive the force from the article. For example, the sensor 612 may be located inside the slip preventing part 637.

The present invention should not be limited to the embodiments described above with reference to the drawings, but the technical scope of the invention encompasses the following embodiments, for example.

(1) Although the overturn preventing device is mounted on the furniture in the foregoing first to sixth embodiments, the overturn preventing device may be mounted on an article such as a bookshelf or a refrigerator which has a possibility of being overturned by shaking of an earthquake or the like.
(2) Although the overturn preventing device is mounted on the furniture installed on the floor surface with its rear surface being opposed to the wall surface in the first to sixth embodiments, the overturn preventing device may be mounted on the furniture or the like installed on the floor surface without being adjacent to the wall surface.
(3) In the first to sixth embodiments, both ends of the damper are respectively coupled to the bases so as to be rotatable about the rotation axes and swingable in the direction intersecting the rotation direction. However, both ends of the damper may not be respectively coupled to the bases so as to be rotatable or swingable.
(4) Although the compression damper is used in the first to sixth embodiments, a two-way damper may be used as long as it can exert a predetermined damping force in a contracting operation.
(5) Although the damper enclosing a hydraulic fluid and a compressed gas in the cylinder is used in the first to sixth embodiments, a fluid-pressure damper enclosing another fluid or another type of damper may be used as long as it can exert a predetermined damping force in a contracting operation.
(6) In the first to sixth embodiments, the compressed gas is enclosed in the cylinder so that an expansion force of the compressed gas acts in an extension direction. However, the force acting in the extension direction may be generated by another manner.
(7) Although the overturn preventing device includes the fall preventing part in the first to sixth embodiments, the overturn preventing device may not include the fall preventing part. Alternatively, the fall preventing part may be formed integrally with the base.
(8) Although the overturn preventing device includes the angle regulator in the first to sixth embodiments, the overturn preventing device may not include the angle regulator. Alternatively, the angle regulator may be formed integrally with the base or the cylinder of the damper.
(9) Although the first and third embodiments show the example of the structure of fixing the attaching member to the base body, any structure capable of fixing the attaching member to the base body may be employed. For example, the insertion part of the attaching member may be fitted in the mounting hole by press fitting, or the attaching member may be fixed to the base body by a coupling member such as a screw.
(10) Although the protrusions are exemplified as the shape-changeable part in the first to fourth embodiments, the shape-changeable part should not be limited to the protrusions. For example, a thin plate-shaped part may be extended from the periphery of the base body into a flange shape, and the flange-shaped part may be disposed in contact with or in proximity to the article or the ceiling. In this case, breakage or deformation occurs easily in the flange-shaped part by shaking or load, and the user can be informed by such breakage or deformation.
(11) Although the first to fourth embodiments show the example in which the protrusions have different breaking strengths, the protrusions may be formed into the same shape and may have the same breaking strength.
(12) Although the first to fourth embodiments show the example in which the protrusions have different breaking strengths, the invention should not be limited to the example. For example, the protrusions may be made of different materials to have different breaking strengths. Alternatively, the protrusions may have respective parts on which stress concentrates and have different widths so that the protrusions have different breaking strengths. Further alternatively, the protrusions may have different projection lengths to have different breaking easiness.
(13) Although the shape-changeable part and the display-changeable part are exemplified in the foregoing embodiments, these are not clearly distinguished concepts and may have both functions. In other words, the shape-changeable part may function as the display-changeable part. For example, a pressure-sensitive sheet or the like may be provided at the location of the protrusion illustrated in the first to fourth embodiments, or a part of the protrusion may be formed of the material of the pressure-sensitive sheet so that the display of the protrusion is changed when a load is applied.
(14) In the fifth embodiment, the members covering the pressure-sensitive sheet (the base body and slip preventing part) are formed as the transparent members so that the pressure-sensitive sheet is visible through the transparent members. However, a through hole or the like may be provided in the members covering the pressure-sensitive sheet so that the pressure-sensitive sheet is visible through the hole.
(15) Although the known pressure sensor capable of detecting a pressure value, or the like is exemplified as the sensor 612 in the sixth embodiment, the sensor 612 may be configured to detect pressure in two stages. For example, the sensor 612 may be configured so that a predetermined part is disconnected when a strong force is applied. In this case, the control 613 is configured not to activate the display 614 when the predetermined part is not disconnected and to activate the display 614 when the predetermined part has been disconnected.
(16) Although the sixth embodiment shows the example in which the control 613 performs control according to the result of detection by the sensor 612, the electrical arrangement should not be limited to this. For example, the electrical arrangement may be configured as illustrated in FIG. 15(B) so that the sensor 612 functions also as a power supply by use of piezoelectric elements or the like thereby to generate electric power according to intense pressure. The display 614 may be configured to emit light when having received electric power of the sensor 612.

### EXPLANATION OF REFERENCE SYMBOLS

C . . . ceiling; F . . . furniture (article); 1, 201, 301, 401, 501, 601 . . . overturn preventing device; 10 . . . damper; 30A, 30B . . . base (30A . . . first base, 30B . . . second base); 31 . . . base body (body); 110, 210, 310, 410 . . . shape-changeable part (informing part); 112, 212, 312, 412 . . . protrusion; 120, 320, 420 . . . mounting hole (mounting portion); 216 . . . bonding layer; 510, 610 . . . display-changeable part (informing part); 512 . . . pressure-sensitive sheet; 612 . . . sensor; and 614 . . . display part.

1. An overturn preventing device comprising:
a damper to be mounted between a top surface of an article installed on an installation surface and a ceiling;
a pair of bases respectively coupled to both ends of the damper, one of the bases being configured to abut against the top surface of the article and the other base being configured to abut against the ceiling; and
an informing part which informs in a case where either base has been subjected to a predetermined load.

2. The overturn preventing device according to claim 1, wherein the informing part has a shape-changeable part which changes a shape thereof when the base has been subjected to the predetermined load.

3. The overturn preventing device according to claim 2, wherein the shape-changeable part has a protrusion disposed on a peripheral edge of the base to extend outward.

4. The overturn preventing device according to claim 3, wherein the shape-changeable part has a plurality of the protrusions disposed on the peripheral edge of the base.

5. The overturn preventing device according to claim 3, wherein the shape-changeable part has a plurality of types of the protrusions disposed on the peripheral edge of the base and having different breaking strengths.

6. The overturn preventing device according to claim 3, wherein the protrusion is independent of a body of the base and the body of the base is provided with a mounting portion for mounting the protrusion.

7. The overturn preventing device according to claim 3, wherein the body of the base and the protrusion are bonded together by a bonding layer.

8. The overturn preventing device according to claim 1, wherein the informing part has a display-changeable part which changes a display thereof when the base has been subjected to the predetermined load.

9. The overturn preventing device according to claim 8, wherein the display-changeable part has a pressure-sensitive sheet which changes a color thereof when the base has been subjected to the predetermined load.

10. The overturn preventing device according to claim 8, wherein the display-changeable part has a detection part which detects pressure or strain caused in the base and a display part which displays a result of detection by the detection part.

11. The overturn preventing device according to claim 1, wherein the informing part is provided at least on the ceiling-side base.
